(19) United States
(12) Patent Application Publication
(10) Pub. No.: US 2012/0056891 A1
(43) Pub. Date: Mar. 8, 2012

(54) MIGRATING AND SAVE RESTORING A VIRTUAL 3D GRAPHICS DEVICE

(75) Inventors: Parag Chakraborty, Sunnyvale, CA (US); Hao Zhang, Sunnyvale, CA (US); Pareekshit Singh, Sunnyvale, CA (US); Pandele Stanescu, Santa Clara, CA (US)

(73) Assignee: Microsoft Corporation, Redmond, WA (US)

(21) Appl. No.: 12/874,235

(22) Filed: Sep. 2, 2010

(51) Int. Cl. G06T 1/20

(52) U.S. Cl. 345/502; 345/522

(57) ABSTRACT

A virtual graphics processing unit within a virtual machine may be restored by causing a reset to the virtual graphics processing unit. The state of the virtual graphics processing unit may not be saved during a migration or save and restore operation, but a reset of the virtual graphics processing unit may cause all applications with processes in the virtual graphics processing unit to re-start and thereby recreate the state of the virtual graphics processing unit. A hypervisor may include a separate graphics processor unit process that may present a virtual graphics processing unit to a virtual machine and communicate with a physical graphics processing unit in hardware. When a virtual machine may be restored after a save or migration, the hypervisor may cause the virtual graphics processor unit to reset and its state to be recreated.

### BACKGROUND

Virtual machines are software implementation of hardware devices. Virtual machines are often used in situations where computing processes may be moved from one hardware platform to another, or where a computing process may be stored and retrieved at a later time. Virtual machines are often used in data centers where an administrator may consolidate several virtual machines onto a single server computer, and may be able to migrate virtual machines to other server computers to balance loads or for other operations.

In many cases, a virtual machine may be migrated or stored while maintaining all of the state for the various components. When a virtual machine may be restored, the state of the processors, memory, and other components may be restored so that the virtual machine may resume operation where it left off when it was stopped.

A conventional graphics processing unit may be a specialized processor that executes graphics related operations, such as creating images that may be presented on a display. Many graphics-intensive programs may use a graphics processing unit to perform many operations, thereby offloading a central processing unit.

### SUMMARY

A virtual graphics processing unit within a virtual machine may be restored by causing a reset to the virtual graphics processing unit. The state of the virtual graphics processing unit may not be saved during a migration or save and restore operation, but a reset of the virtual graphics processing unit may cause all applications with processes in the virtual graphics processing unit to re-start and thereby recreate the state of the virtual graphics processing unit. A hypervisor may include a separate graphics processor unit process that may present a virtual graphics processing unit to a virtual machine and communicate with a physical graphics processing unit in hardware. When a virtual machine may be restored after a save or migration, the hypervisor may cause the virtual graphics processor unit to reset and its state to be recreated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a virtual graphics processing unit.

FIG. 2 is a flowchart illustration of an embodiment showing a method for creating and pausing a virtual machine.

FIG. 3 is a flowchart illustration of an embodiment showing a method for restoring and operating a virtual machine with a virtual graphics processing unit.

### DETAILED DESCRIPTION

A hypervisor system may present a virtual graphics processing unit to a virtual machine. The virtual machine may create processes and send instructions to the virtual graphics processing unit in the same manner as the virtual machine may create processes and send instructions to a central processing unit.

When a virtual machine may be restored, such as after a save or migration operation, a hypervisor may actively or passively cause the virtual graphics processing unit to be reset. The reset operation may cause all of the applications that have processes executing on the virtual graphics processing unit to re-send data and/or restart those processes, effectively re-creating the state within the virtual graphics processing unit.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

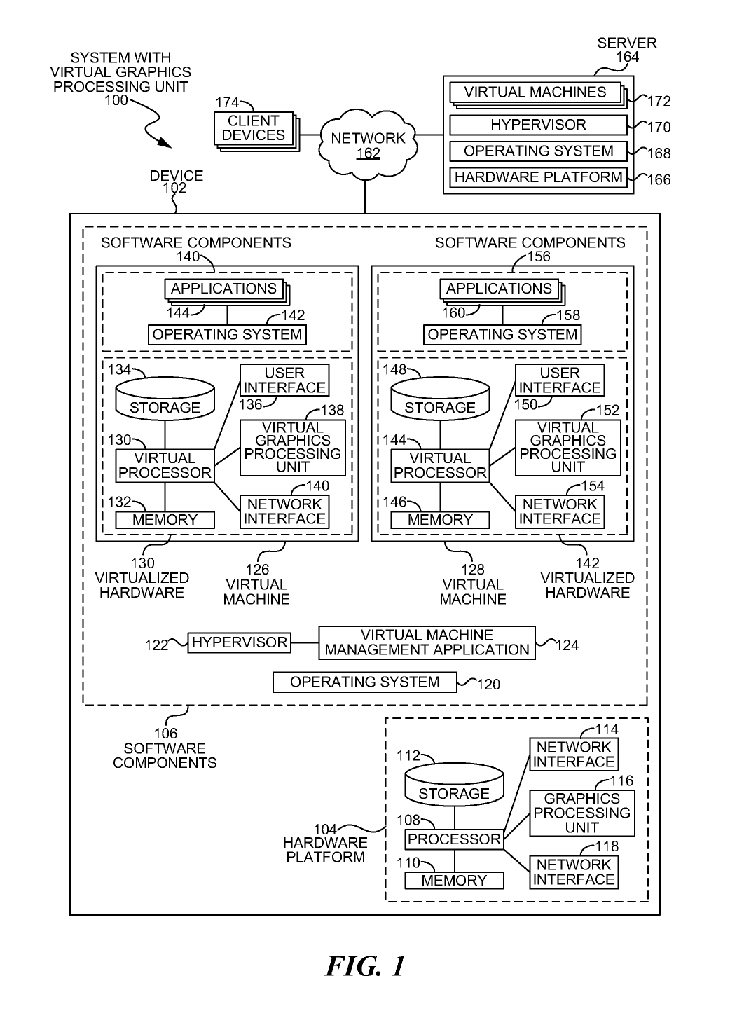

FIG. 1 is a diagram of an embodiment 100, showing a system for operating a virtual machine where the virtual machine has a virtual graphics processing unit. Embodiment 100 is a simplified example of a hardware and software environment in which virtual machines may be operated and in which virtual machines may be saved, restarted, relocated, and otherwise manipulated.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

A virtual machine may have a virtual graphics processing unit made available through a hypervisor. The virtual graphics processing unit may receive commands for display-related computations and perform the computations to generate a user interface that may be displayed to a user.

In many systems, graphics processing units may be a specialized microprocessor that may offload graphics-intensive processing from a main processor. In a virtual machine, a virtual version of a graphics processing unit may be provided to the virtual machine and used in the same way a physical virtual processing unit may be used by software operating natively on a hardware platform.

In many systems, a hardware graphics processing unit may perform complex rendering, shading, three dimensional effects, and other computationally intensive operations. A virtual graphics processing unit may perform the same commands for a virtual machine.

Graphics processing units, both physical and virtual, in general perform computations that relate to rendering displays for a user interface and may or may not perform other computations that may process user data or application data. In general, graphics processing units are specialized to render images or generate displays in a time-sensitive manner One example may be rendering displays in real time for an interactive game.

Many embodiments of a physical graphics processing unit may include a reset or timeout function. The reset or timeout function may cause the physical graphics processing unit to reset so that the real time processing of a display may be continued in the event of an infinite loop or software crash. In a conventional physical graphics processing unit, such a reset may cause a display to stutter or flicker, then continue operations. Such resets may have a perceptible but minimal hesitation to a display.

Various physical graphics processing units may have different manners for handling a reset function. In many cases, a reset may cause all of the memory and instruction queues within the graphics processing unit to be erased. In some embodiments, the reset may cause any applications or operating system functions that may have transmitted instructions to the graphics processing unit to re-send such instructions to the graphics processing unit. In some embodiments, the applications or operating system functions may receive a notification to re-send instructions. In other embodiments, the applications or operating system functions may wait for a response from the graphics processing unit and may re-send instructions after a period of time has elapsed and when no response was received.

Virtual machines may be software emulations of physical computer devices. A virtual machine may behave like a physical computer and may have an operating system and execute various applications. One of the benefits of a virtual machine is that the virtual machine may be moved from one hardware platform to another or saved and restored at a later time.

In order to accomplish storing and restarting the virtual machine, a hypervisor may store all of the state related to the virtual machine prior to pausing the virtual machine. The state may include all of the items stored in memory, the state of a central processing unit, any processing queues or memory queues, as well as the state of any peripheral devices, such as storage devices or network devices. When a hypervisor restarts or restores a virtual machine, the hypervisor may re-create all the state so that the virtual machine may begin operation from the same state prior to pausing.

With the graphics processing unit, however, the hypervisor may not store a complete state for a virtual graphics processing unit. When a virtual machine is resumed, the hypervisor may cause the virtual graphics processing unit to perform a reset. The virtual graphics processing unit reset, in a similar fashion to a physical graphics processing unit reset, may cause the virtual graphics processing unit to clear itself of any stored items, such as memory items or instruction queues. When the virtual graphics processing unit is reset, the memory items or instruction queues may be regenerated by the various applications or operating system functions.

Because the virtual graphics processing unit may be reset and its state regenerated easily, the state of the virtual graphics processing unit may not be stored by a hypervisor but may be regenerated when a virtual machine may be restored after a save, migration, or other action. This may reduce the complexity of storing and recreating the virtual machine state.

The device 102 may be a server or other computer system on which one or more virtual machines may operate. The device 102 may have a hardware platform 104 in which several software components 106 may operate. The device 102 may represent a conventional computer device, although other embodiments may have a subset or superset of the components described.

In a datacenter or commercial implementation, the device 102 may be a server computer that may have robust components designed for heavy usage. In other embodiments, the device 102 may be a personal computer, game console, laptop computer, netbook computer, personal digital assistant, mobile telephone, or other device.

The hardware platform 104 may include a processor 108, random access memory 110, and nonvolatile storage 112. In some embodiments, the processor 108 may include several cores or independent processors. The nonvolatile storage 112 may be locally accessible storage or network accessible storage in different embodiments.

The hardware platform 104 may include a user interface 114, a graphics processing unit 116, and a network interface 118. The user interface 114 may include input and output devices, such as displays, keyboards, and pointing devices, among others. The network interface 118 may be a wireless or wired connection to a network.

The graphics processing unit 116 may be a specially designed processor configured to process graphics related instructions. In many cases, the graphics processing unit 116 may be specially designed to perform large numbers of certain types of computations, such as large numbers of floating point computations or large matrix operations in parallel.

The software components 106 may include an operating system 120 and a hypervisor 122. The hypervisor 122 may create a virtual hardware platform on which virtual machines may operate.

Hypervisors are often implemented in two types. A “Type 1” hypervisor may be a hypervisor that runs natively on a hardware platform and provide virtualized versions of hardware to one or more virtual machines. A “Type 2” hypervisor may be an application that runs within an operating system, where the operating system executes natively on the hardware platform. Embodiment 100 illustrates a type 2 hypervisor that may operate as an application executed within the operating system 120.

The device 102 is illustrated as having two virtual machines 126 and 128. Each virtual machine may operate separately and independently from each other, and may have different operating systems and applications from each other. In many embodiments, a single device may have several virtual machines operating in parallel.

The virtual machine 126 may have a set of virtualized hardware 130 and some software components 140. Similarly, the virtual machine 128 may have a set of virtualized hardware 142 and some software components 156.

The virtualized hardware 130 and 142 may include virtualized processors 130 and 144, virtualized memory 132 and 146, and virtualized storage 134 and 148. Additionally, the virtualized hardware 130 and 142 may include a virtualized user interface 136 and 150, a virtualized graphics processing unit 138 and 152, and a virtualized network interface 140 and 154.

In many embodiments, the hypervisor 122 may create a thread or process that may bind a virtualized component to a physical component. For example, a hypervisor may create a process that simulates a virtual processor by creating an input and output buffer similar to a physical processor, then transferring items in the input buffer to a physical processor. The same process may retrieve results from the physical processor and present the results in a virtualized output buffer.

Similarly, the hypervisor 122 may create a second thread or process that links the virtual graphics processing units 138 and 152 to the physical graphics processing unit 116. In many embodiments, a hypervisor may have separate threads or processes that provide graphics processing unit services and central processing unit services to each virtual machine.

Each virtual machine 126 and 128 may have the same or different virtualized hardware platforms. In some cases, a hypervisor may allow an administrator to create a virtual machine with different amounts of memory, storage, processor capabilities, network configurations, and other capabilities. In some embodiments, a hypervisor may allow a virtual machine to be created with or without a virtual graphics processing unit. Some embodiments may allow different kinds of virtual graphics processing units to be created, which may have different command sets or different functionalities. In some such embodiments, the virtual graphics processing units may be emulators that may or may not correspond with the physical graphics processing unit 116.

In some embodiments, the virtual graphics processing units may correspond with the physical graphics processing unit 116. In such embodiments, the capabilities of the physical graphics processing unit 116 may be made available through a virtual graphics processing unit, and the functions, capabilities, and command sets of the physical graphics processing unit 116 may be extended to the virtual graphics processing unit. Such embodiments may have a process or thread that receives commands from a virtual graphics processing unit and transmits the commands to the physical graphics processing unit, then return any results to the virtual graphics processing unit. Such embodiments may or may not provide additional commands or functionalities over and above that of the physical graphics processing unit.

Each virtual machine 126 and 128 may have various software components 140 and 156. For each virtual machine, a different operating system 142 and 158 may be used. In some cases, the same operating system may be used for each virtual machine, but the operating systems may be two separate instances of the same operating system. Similarly, each virtual machine 126 and 128 may have different applications 144 and 160 that may execute on the virtual machine.

In many embodiments, a virtual machine management application 124 may allow an administrator to perform various administrative tasks with the virtual machines. The virtual machine management application 124 may allow the administrator to create and configure a virtual machine, which may involve determining and setting all of the configurations for the various virtualized hardware components.

The virtual machine management application 124 may allow an administrator to perform various operational functions with the virtual machines. For example, an administrator may be able to start and stop a virtual machine, as well as save and restore virtual machines. In some embodiments, an administrator may be able to move virtual machines to different hardware platforms.

For example, some virtual machine management applications may allow an administrator to communicate over a network 162 to a server 164. The server 164 may have a hardware platform 166 on which an operating system 168 and a hypervisor 170 may operate. The server 164 may host several virtual machines 172.

The virtual machine management application 124 may allow an administrator to move virtual machines from one host device to another. For example, an administrator may move the virtual machine 126 from the device 102 to the server 164. It should be noted that in some embodiments, the virtual machine management application 124 may perform many operations automatically, including determining when to save or move a virtual machine and when to restore a virtual machine.

During a move operation, a virtual machine may be saved on one hardware platform and restarted on a different hardware platform. During a save and restore operation, the state of a virtual machine may be captured and stored on the first hardware platform, then recreated on the second hardware platform.

When a virtual machine has a virtual graphics processing unit, a hypervisor or other application may send a command during a restore operation to reset the virtual graphics processing unit. The effect of the reset of the virtual graphics processing unit may cause any applications or processes that have commands being executed by the virtual graphics processing unit to re-send the commands. In this manner, the state of the virtual graphics processing unit may be re-created by the applications, rather than having the hypervisor store and re-store the state of the virtual graphics processor as part of a restore operation.

In many embodiments, one or more client devices 174 may access one of the virtual machines that has a virtual graphics processing unit. The client devices 174 may use various technologies to access the virtual machine, where the virtual machine may generate a user interface that is displayed on the client device. The user interface provided by the virtual machine may be generated in part by a virtual graphics processing unit.

While one of the client devices 174 is communicating with a virtual machine, the virtual machine may be migrated to another hardware platform. The migration operation may include pausing the virtual machine on one hardware platform and restoring the virtual machine on another hardware platform. In many embodiments, such operations may be performed very rapidly so that the user may or may not notice that the virtual machine has migrated. Such embodiments may move most of the state while the virtual machine is fully operational on the first hardware platform, then transfer any changed state at the point in time that the virtual machine is stored. Such embodiments may transfer a small portion of the state during the period of time that the virtual machine is saved, allowing the virtual machine to restore in a very short period of time.

When the virtual machine is restored, the virtual graphics processing unit may be reset by a hypervisor. The reset operation may cause a slightly noticeable pause in the performance of a user interface in some embodiments. In some cases, any performance changes due to resetting the virtual graphics processing unit may not be noticeable.

When a virtual machine is restored, the virtual graphics processing unit may be reset in different manners. In one manner, the physical graphics processing unit may be reset, causing both of the virtual graphics processing units 138 and 152 to be reset. In another manner, a hypervisor may cause a reset to occur with only the virtual graphics processing unit associated with the restored virtual machine. In such a manner, any other virtual graphics processing units operating on the hardware platform may continue to operate without interruption.

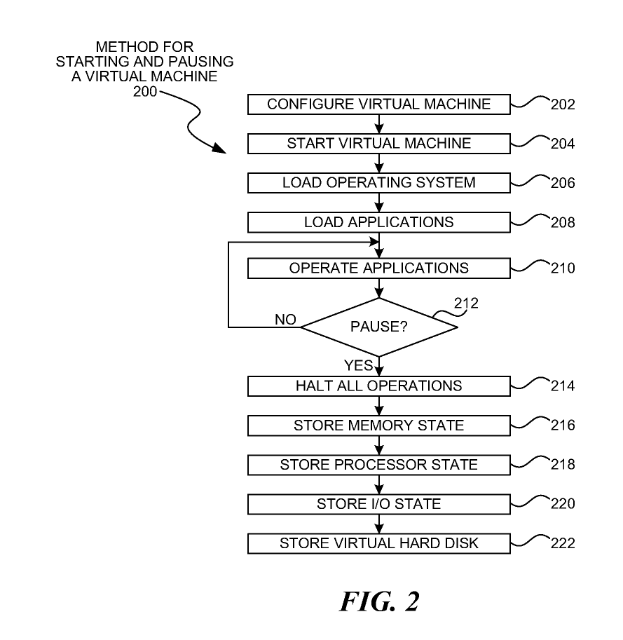

FIG. 2 is a flowchart illustration of an embodiment 200 showing a method for saving and restoring a virtual machine. The process of embodiment 200 is a simplified example of how a virtual machine may be configured, operated, and saved in preparation for migration or resumption at a later time.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a simplified process for operating a virtual machine. The virtual machine may be configured and then operated. At some point after the virtual machine has been operating, the virtual machine may be saved and the virtual machine's state may be stored. Embodiment 300 represents an example of how a paused virtual machine may be restored.

The virtual machine may be configured in block 202. The configuration process may involve allocating resources to a virtual machine, such as allocating various central processing units, memory, storage, and network connections to the virtual machine. In many embodiments, the configuration of a virtual machine may involve selecting one or more processors that the virtual machine may use, along with selecting and configuring a virtual graphics processing unit.

The virtual machine may be started in block 204. An operating system may be installed and loaded in block 206. After the operating system is operational, various applications may be installed in block 208 and executed in block 210. The virtual machine may operate in block 210 and loop through block 212 until a save command is executed in block 212.

The save command may be used to halt the virtual machine and allow a hypervisor to restore operations of the virtual machine at a later time. In some cases, the virtual machine may be moved to a different hardware platform and restored. The save command may store the state of the virtual machine so that the state may be re-created and the virtual machine restored. Such a type of save and restore operation may pause the virtual machine in the middle of operations and allow the virtual machine to resume precisely where the virtual machine was paused.

In block 214, all operations may be halted. The memory state may be stored in block 216 and the processor state may be stored in block 218. The input/output state of all peripheral devices, such as storage devices, network devices, display devices, and the like may be stored in block 220. In block 222, a virtual hard disk may be stored.

In some embodiments, the state of the virtual machine may be stored in the virtual hard disk. In other embodiments, the state of the virtual machine may be stored separately from the virtual hard disk.

When storing the state of the virtual machine, the processor state may include any commands queued, as well as register settings, memory contents, and any other state information. During the restore process, an example of which is illustrated in embodiment 300, the state may be restored so that the processor may execute the next command in the queue as if no pause occurred.

When storing the state of the virtual machine, the state of a virtual graphics processing unit may not be stored. In such embodiments, the virtual graphics processing unit state may be re-created by performing a reset operation on the virtual graphics processing unit.

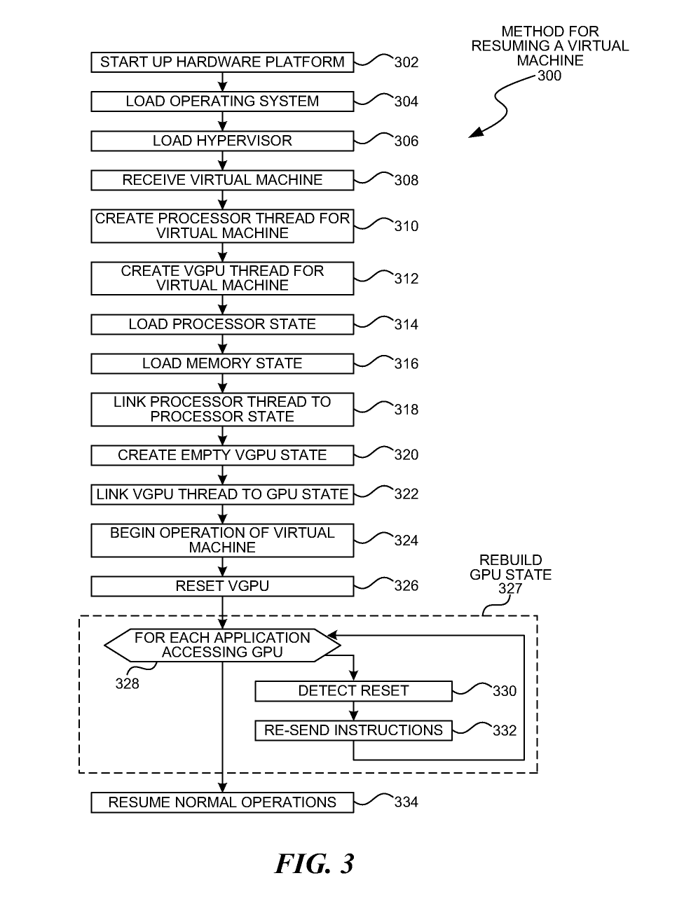

FIG. 3 is a flowchart illustration of an embodiment 300 showing a method for restoring a virtual machine. The process of embodiment 300 is a simplified example of how a virtual machine may be restored, including restoring the state of various components. Embodiment 300 is an example of a process where the state of a virtual graphics processing unit may not be restored from a stored state, but by resetting the virtual graphics processing unit.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example illustrating a hardware platform that is started, a virtual machine is loaded, and the state is restored prior to restoring the virtual machine. When the virtual machine is restored, the virtual graphics processing unit of the virtual machine may be reset, causing the state of the virtual graphics processing unit to be re-created from the various applications that access the virtual graphics processing unit.

The hardware platform may be started in block 302 and an operating system may be loaded in block 304. A hypervisor may be loaded in block 306. In other embodiments, a hypervisor may be loaded initially.

The virtual machine may be received in block 308. The virtual machine may include state for the various components, such as the processor and memory.

A processor thread may be created in block 310 for the virtual machine. The processor thread may receive commands for a virtual processor and cause those commands to be executed on a physical processor.

A virtual graphics processor thread may be created in block 312 for the virtual machine. The virtual graphics processor thread may receive commands for a virtual graphics processing unit and cause those commands to be executed. In many embodiments, the virtual graphics processor thread may cause the virtual graphics processor commands to be executed on a physical virtual graphics processing unit. In other embodiments, the virtual graphics processor thread may cause the virtual graphics processor commands to be executed by an emulator which may simulate a physical graphics processing unit.

The processor state may be loaded in block 314. The processor state may include memory objects stored in the processor, along with various instruction queues, output queues, and registers.

The memory state may be loaded in block 316. The memory state may include all of the memory objects as they were prior to pausing the virtual machine.

The processor thread may be linked to the processor state in block 318.

An empty virtual graphics processing unit may be created in block 320. The virtual graphics processor thread may be linked to the virtual graphics processing unit in block 322.

The virtual machine may resume operation in block 324.

In block 326, the virtual graphics processing unit may be reset. In some embodiments, a hypervisor may send a reset command or otherwise actively cause the virtual graphics processing unit to be reset. In other embodiments, the empty state of the virtual graphics processing unit may be detected by the virtual machine and may cause the virtual graphics processing unit to be reset. Such an embodiment may passively cause a reset to occur.

In another example of a passive reset, the hypervisor may pause the virtual graphics processing unit thread until the virtual machine determines that the virtual graphics processing unit is halted. The virtual machine may then issue a reset command to the virtual graphics processing unit.

Once the virtual graphics processing unit is reset in block 326, the state of the virtual graphics processing unit may be rebuilt in block 327. For each application that accessed the virtual graphics processing unit in block 328, the reset may be detected in block 330 and any instructions to the virtual graphics processing unit may be re-sent in block 332. After each application re-sends the instructions, the state of the virtual graphics processing unit may be re-built or re-created without having to store the state of the virtual graphics processing unit.

Once the state is restored, the virtual machine may resume normal operations in block 334.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a processor;
a first virtual machine operable on said processor, said first virtual machine having a first virtual graphics processing unit;
a hypervisor operable on said processor, said hypervisor comprising a graphics processor unit thread configured to receive instructions from a virtual graphics processing unit and cause said instructions to be performed; and
said hypervisor further configured to detect that said first virtual machine is being restored and cause said first virtual graphics processing unit to be reset.

2. The system of claim 1, said hypervisor further configured to cause said first virtual graphics processing unit to be reset by transmitting a reset command to said first virtual graphics processing unit.

3. The system of claim 1, said hypervisor further configured to cause said first virtual graphics processing unit to be reset by pausing said instructions from said first virtual graphics processing unit to simulate a hung graphics processing unit.

4. The system of claim 1 further comprising:
a physical graphics processing unit.

5. The system of claim 4, said graphics processor unit thread further configured to cause said instructions to be performed by transmitting said instructions to said physical graphics processing unit.

6. The system of claim 1, said virtual machine being restored as a result of a migration operation.

7. The system of claim 1, said virtual machine being restored as a result of a restore operation.

8. The system of claim 1 further comprising:
a second virtual machine operable on said processor, said second virtual machine having a second virtual graphics processing unit.

9. The system of claim 8,
said hypervisor further configured to detect that said second virtual machine is being restored and cause said second virtual graphics processing unit to be reset without causing said first virtual graphics processing unit to be reset.

10. The system of claim 8,
said hypervisor further configured to detect that said second virtual machine is being restored and reset said physical graphics processing unit to cause said first graphics processing unit and said second graphics processing unit to be reset.

11. A method performed on a computer processor, said method comprising:
receiving a virtual machine, said virtual machine have a virtual processor state and a memory state, said virtual machine having a virtual graphics processing unit;
restoring said virtual processor state and said memory state in a hypervisor;
resuming said virtual machine on said computer processor;
detecting that said resume has occurred; and
causing said virtual graphics processing unit to be restarted based on said detecting.

12. The method of claim 11, said causing said virtual graphics processing unit to be restarted being performed by sending a restart command to said virtual graphics processing unit.

13. The method of claim 11, said causing said virtual graphics processing unit to be restarted being performed by pausing said virtual graphics processing unit until said virtual machine performs a reset on said virtual graphics processing unit.

14. The method of claim 11, said causing said virtual graphics processing unit to be restarted being performed by clearing said virtual graphics processing unit of instructions to perform.

15. The method of claim 11 further comprising:
not restoring a state to said virtual graphics processing unit.

16. A computer readable storage medium comprising computer executable instructions configured to perform the method of claim 11.

17. A method comprising:
receiving a first virtual machine, said first virtual machine having a first virtual processor state and a first memory state, said first virtual machine having a first virtual graphics processing unit;
restoring said first virtual processor state and said first memory state in a hypervisor;
providing a first processor thread for said first virtual machine, said first processor thread receiving processor instructions from a virtual processor and transmitting said processor instructions to a real processor;
providing a first graphics processing unit thread for said first virtual graphics processing unit, said first graphics processing unit thread receiving graphics instructions from said virtual graphics processing unit and transmitting said graphics instructions to a real graphics processing unit;
resuming said first virtual machine on said computer processor, said resuming comprising operating a first virtual processor using said first virtual processor state and said first memory state and starting said first virtual processor and said first virtual graphics processing unit; and
detecting that said first virtual machine has resumed; causing said first virtual graphics processing unit to be restarted based on said resume.

18. The method of claim 17 further comprising:
receiving a second virtual machine, said second virtual machine having a second virtual processor state and a second memory state, said second virtual machine having a second virtual graphics processing unit;
restoring said second virtual processor state and said second memory state in said hypervisor;
providing a second processor thread for said second virtual machine;
providing a second graphics processing unit thread for said second virtual graphics processing unit;
resuming said second virtual machine on said computer processor, said resuming comprising operating a second virtual processor using said second virtual processor state and second first memory state and starting said second virtual processor and said second virtual graphics processing unit; and
detecting that said second virtual machine has resumed and causing said second virtual graphics processing unit to be restarted based on said resume.

19. The method of claim 18, said second virtual graphics processing unit being restarted without restarting said first virtual graphics processing unit.

20. The method of claim 18, said second virtual graphics processing unit being restarted at the same time as said first virtual graphics processing unit.
